(19) United States
(12) Patent Application Publication
(10) Pub. No.: US 2009/0163051 A1
(43) Pub. Date: Jun. 25, 2009

(54) Socket for semiconductor device

(75) Inventor: Ryu Miki, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/314,587

(22) Filed: Dec. 12, 2008

(30) Foreign Application Priority Data
Dec. 19, 2007 (JP) 327377/2007

(51) Int. Cl. H01R 12/00

(52) U.S. Cl. 439/68

(57) ABSTRACT

A socket for a semiconductor device which can be used in a multipurpose manner with plural semiconductor device having electrode terminals of varying shapes. The socket for a semiconductor device according to an embodiment of this invention has a contact terminal placing an electrode terminal of the semiconductor device in abutment and electrical connection, an IC mount mounting a substrate face forming an electrode terminal of the semiconductor device, and an adjustable IC mount shifting unit enabling adjustment of a separation distance of an upper surface of the contact terminal and an upper surface of the IC mount in order to maintain normal electrical connection between the contact terminal and an electrode terminal of the semiconductor device irrespective of the shape of an electrode terminal of the semiconductor device.

### FIELD OF THE INVENTION

The present invention relates to a socket for a semiconductor device used when testing electrical characteristics of the semiconductor device.

### BACKGROUND OF THE INVENTION

Prior to shipment of semiconductor devices (hereafter “IC packages”), electrical characteristics are tested using a socket for semiconductor devices (hereafter “IC socket”) which functions as a connector to connect the IC package to an electrical circuit board.

FIG. 10 is a sectional view of a first related example of an IC socket 5 mounting a BGA (ball grid array) IC package 550 [refer to FIG. 11 in Japanese Unexamined Patent Application Publication No. Hei11-97137 (Patent Document 1)]. The IC socket 5 includes a socket main body 510, a socket contact (contact pin) 530, a contact terminal 531, a spring member 532, a pin 533, a lid 540, a latch 542, a guide 511 and a solder ball (ball terminal) 553.

In the first IC socket 5 according to the first related example, the socket contact 530 is embedded into the socket main body 510. The socket contact 530 includes a contact terminal 531 making electrical contact with an electrode terminal (solder ball 553) of the IC package 550, the spring member 532 stably retaining the electrical contact with the electrode terminal and the pin 533 leading the electrical signal outside the socket.

An IC mount 520 is provided in the socket main body 510 so that a substrate face where the electrode terminal of the IC package 550 is provided abuts the IC mount and is mounted thereon. The guide 511 is provided on the side face of the socket main body 510 to position the IC package 550. The lid 540 is mounted via a hinge 541 on one side of the socket main body 510. The latch 542 fixing the lid 540 is mounted on the other side of the socket main body 510.

In order to achieve multi-purpose functioning, an IC socket has been proposed in which measurement of the characteristics of various types of IC packages is possible with a single IC socket (FIG. 1(b) in Japanese Unexamined Patent Application Publication No. 11-102763, FIG. 1 in Japanese Unexamined Patent Application Publication No. 11-26124, or FIG. 1 in Japanese Unexamined Patent Application Publication No. 2002-246132 (Patent Documents 2-4)).

FIG. 11 shows a cutaway sectional view of an IC socket 6 according to a second related example [FIG. 1(b) in Japanese Unexamined Patent Application Publication No. 11-102763 (Patent Document 2)]. As shown in FIG. 11, the IC socket 6 according to the second related example includes a substrate 612, a contact pin 630, a base lid 640, a shaft 641, a press lid 642, and a lock lever 643.

The contact pin 630 is embedded in the substrate 612 of the IC socket 6 according to the second related example to provide electrical connection with the IC package 650. The base lid 640 is fixed to the substrate 612 by the shaft 641 and the lock lever 643. A tap is cut into the base lid 640 so as to be adapted to the threaded section of the press lid 642. The press lid 642 is screwed into the tap. When the IC package 650 is set into the IC socket 6, the base lid 640 is arranged to cover the IC package 650, and then the lock lever 643 is used to fix the base lid 640 to the substrate 612. The IC package 650 is pressed at a suitable pressure by screwing in the press lid 642 with the tap of the base lid 640 so as to adapt the ball to the contact pin 630.

FIG. 12 shows a cutaway sectional view of an IC socket 7 according to FIG. 1 in Japanese Unexamined Patent Application Publication No. 11-26124 (Patent Document 3). The IC socket 7 disclosed in Patent Document 3 as shown in the same FIGure includes an IC mount 720 positioning and retaining an IC package 750, a contact pin 730 passing through the IC mount 720 and making contact with each electrode terminal 7 of the IC package 750, a pressing block 741 pressing the IC package 750 towards the IC mount 720, and an IC socket main body 710 housing the above components. A pressing block shifting unit 742 varying the distance of the pressing block 741 relative to the IC mount 720 is provided on the back face of the pressing block 741.

FIG. 1 in Japanese Unexamined Patent Application Publication No. 2002-246132 (Patent Document 4) proposes a method of separating the socket main body into an upper plate and a lower plate to perform height adjustment and exchanging only the upper plate according to the type of package.

### SUMMARY OF THE INVENTION

An IC socket as disclosed in Patent Documents 2-4 is an IC socket in which measurement of the characteristics of various types of IC packages is possible with a single IC socket.

However, stability is sometimes adversely affected by the shape of the electrode terminal in the IC socket 6 disclosed in Patent Document 2 since only the electrode terminal is placed in contact with the lower face of the IC package 650.

Furthermore since the separation distance between the face of the IC mount 720 and the contact pin 730 is fixed in an IC socket 7 disclosed by Patent Document 3, it is not possible to adapt the socket to IC packages 750 in which the projecting height of the electrode terminal varies.

An IC socket disclosed in Patent Document 4 adopts an arrangement in which an upper plate is exchanged according to the structure of the IC package. Consequently the upper plate must be exchanged each time a different type of electronic component (IC package) is measured.

A socket for a semiconductor device according to an aspect of the present invention has a contact terminal placing an electrode terminal of the semiconductor device in abutment and electrical connection, an IC mount mounting a substrate face forming an electrode terminal of the semiconductor device, and an adjustable IC mount shifting unit enabling adjustment of a separation distance between an upper surface of the contact terminal and an upper surface of the IC mount in order to maintain normal electrical connection between the contact terminal and an electrode terminal of the semiconductor device irrespective of the shape of an electrode terminal of the semiconductor device.

Since the socket for a semiconductor device according to another aspect of this invention is provided with an IC mount shifting unit allowing variation of the height of the IC mount, it is possible to adjust the separation distance between the contact terminal and the IC mount according to the shape of the electrode terminal disposed on the semiconductor device.

As a result, it is possible to place the contact terminal in contact with the electrode terminal of the semiconductor device at a suitable pressure. Furthermore since an IC mount shifting unit is provided in the socket for a semiconductor device, adjustment and management of the height of the contact terminal of the IC socket and the electrode terminal of the IC package is simplified.

According to this invention, an excellent effect is obtained by providing a multipurpose socket for a semiconductor device for plural semiconductor devices having electrode terminals of various shapes.

### BRIEF DESCRIPTION OF THE DRAWINGS

FIG. 1 is a schematic sectional view of an IC socket according to a first embodiment;

FIG. 2 is a schematic plan view of the main components of an IC socket 1 according to the first embodiment;

FIG. 3 shows a partial enlarged sectional view of an IC socket 1 according to the first embodiment;

FIG. 4A is a schematic plan view of a screw lock disposed in an IC socket according to a first embodiment;

FIG. 4B is a schematic plan view of a screw lock disposed in an IC socket according to a modification;

FIG. 5A is a sectional view of an IC-package-mounted IC socket along the line V(a)-V(a) in FIG. 2;

FIG. 5B is a sectional view of an IC-package-mounted IC socket along the line V(b)-V(b) in FIG. 2;

FIG. 6A shows a sectional view corresponding to FIG. 5A of an IC-package-mounted IC socket prior to providing ball terminals;

FIG. 6B is a sectional view corresponding to FIG. 5B of an IC-package-mounted IC socket prior to providing ball terminals;

FIG. 7 shows a schematic plan view of the main components of an IC socket according to a second embodiment;

FIG. 8A is a cutaway sectional view along the line VIII(a)-VIII(a) in FIG. 7;

FIG. 8B is a cutaway cross sectional view along the line VIII(b)-VIII(b) in FIG. 2;

FIG. 9 is a schematic plan view of the main components of an IC socket according to a modification;

FIG. 10 is a cutaway sectional view of an IC socket according to a first related example;

FIG. 11 is a cutaway sectional view of an IC socket according to a second related example; and

FIG. 12 is a cutaway sectional view of an IC socket according to a third related example.

### DETAILED DESCRIPTION OF THE PREFERRED EMBODIMENTS

An example of an embodiment according to the present invention will be described hereafter. However it goes without saying that other embodiments may be made within the scope of the present invention without departing from the spirit of the present invention.

### First Embodiment

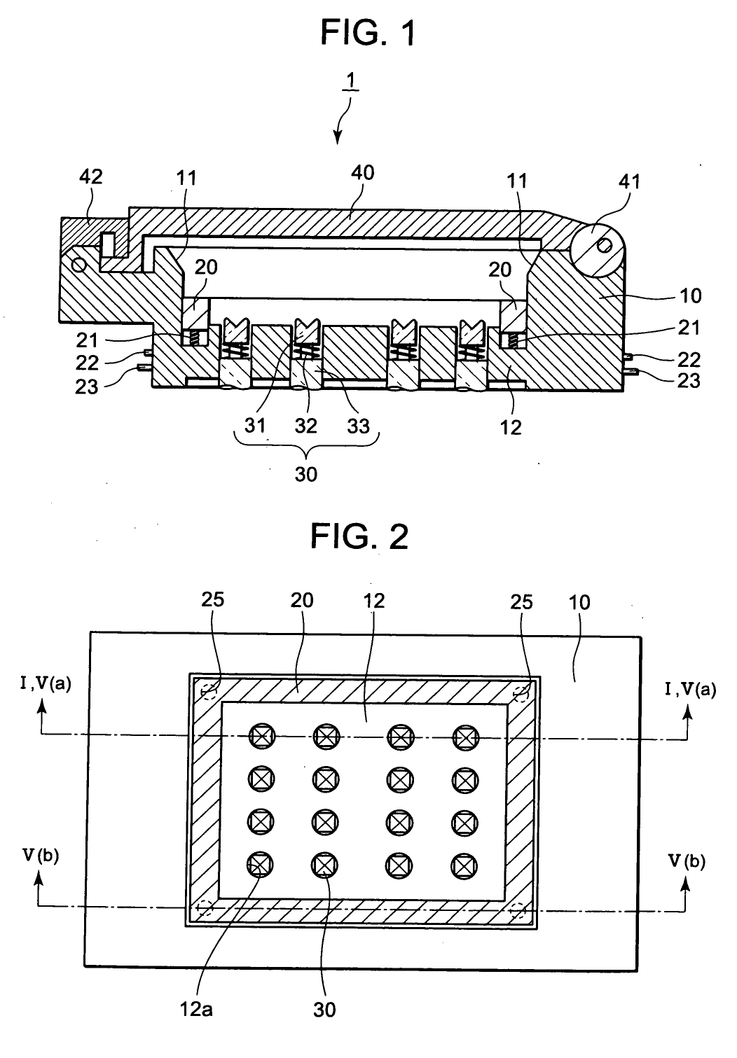

FIG. 1 is a sectional view explaining an example of a semiconductor socket (hereafter “IC socket”) 1 according to a first embodiment. FIG. 2 is a schematic plan view of the main components of an IC socket 1 according to the first embodiment. The cutaway cross sectional face I-I in FIG. 2 corresponds to FIG. 1. In the sectional views hereafter, screws and springs which are originally shown in cross sectional view, are not shown as sectional views for the sake of convenience of description.

The IC socket 1 is adapted to electrically connect the electrode terminal of the IC package and the circuit board of the IC testing device in order to test the characteristics of the semiconductor device (hereafter “IC package”). The IC socket 1 as shown in the same figure is provided with a socket main body 10, an IC mount (sheeting section) 20, a contact pin 30 and a lid 40 functioning as a base.

The socket main body 10 is formed from an insulating material and functions as a housing. A guide 11 is provided on an upper side section of the socket main body 10 to lead the IC package (not shown) to the IC mount 20. The electrode terminals of the IC package mounted on the socket main body 10 are disposed at positions corresponding to contact terminals by the guide 11. A plate-shaped base 12 is provided on the lower face of the socket main body 10. A through hole 12a is provided in the base 12 to embed the contact pin 30.

The contact pin 30 is formed with the same pitch as the electrode terminal of the IC package and a part thereof is embedded in the through hole of the base 12. As shown in FIG. 1, the contact pin 30 is provided with a contact terminal (pogo pin) 31, a spring member 32, and a pin 33. The tip of the contact terminal 31 is placed in electrical connection by contact with the electrode terminal of the IC package. From the point of view of facilitating contact with the electrode terminal of the IC package, at least the tip of the contact terminal 31 as shown in FIG. 1 should preferably have a height equal to the surface of the base 12 or should project from the surface of the base 12.

The contact terminal 31 as shown in FIG. 2 has a shape in which the tip is slotted and forms a circular cone. The contact terminal 31 is supported by the spring member 32 and therefore it can be moved slightly in a vertical direction. The spring member 32 buffers shocks during contact of the contact terminal 31 of the contact pin with the electrode terminal of the IC package. Since the distance between the electrode terminal and the contact terminal is not adjusted by the spring member, the stroke of the contact terminal can be reduced. In other words, it is possible to reduce the length of the spring member. As a result, increase in parasitic components of the contact pin can be suppressed and thus deterioration of high frequency characteristics can be prevented. Since the distance between the electrode terminal and the contact terminal is not adjusted by the spring member, it is possible to approximately fix the length of the contact pin 30 through which the signal passes independently of the shape of the electrode terminal of the IC package. As a result, stable testing is enabled irrespective of the shape of the electrode terminal of the IC package.

A contact terminal (not shown) is provided on the tip opposite the contact terminal 31 of the contact pin 30 to make contact with the pad of the circuit board of the IC testing device. The tip of the contact pin abutting with the IC testing device projects from the rear face of the base 12. The IC socket 1 according to the first embodiment houses the IC package (not shown) internally, places the contact terminal 31 of the contact pin 30 in contact with the electrode terminal of the IC package and measures the electrical characteristics by setting the contact terminal (not shown) projecting from the rear face of the base 12 in the circuit board of the IC testing device. The description above has explained an example in which the pin 33 of the contact pin 30 is fixed to the base 12 provided on the socket main body 10. However the invention is not limited in this respect and contact pins of various arrangements may be employed without departing from the spirit of the present invention.

The lid 40 is rotatably mounted via a hinge 41 on one side of the socket main body 10. The lid 40 has the function of sealing the inner section after setting the IC package into the IC socket. When the lid 40 is closed with respect to the socket main body 10, the lid 40 is locked by the latch 42 to prevent the lid 40 from opening. The loaded IC package is placed in suitable abutment with the IC mount 20 by fixing the lid 40 with the latch 42.

The IC mount 20 is mounted by the IC mount shifting unit onto the top of the base 12 of the socket main body 10. The IC mount 20 mounts and places in abutment the substrate face forming the electrode terminal of the IC package.

As shown in FIG. 2, the IC mount 20 is formed in a frame shape. A proximal region of the outer peripheral section of the substrate face of the IC package abuts with the frame-shaped IC mount 20 and is mounted thereon. The height of the IC mount 20 can be shifted upwardly by the IC mount shifting unit.

The IC mount shifting unit according to the first embodiment has a screw making contact towards the rear face 20b of the IC mount 20 and is a unit which can adjust the height of the screw. The respective tips of the screws make contact with the corners of the rear face of the IC mount 20. A screw fitting section 25 (not shown) is provided to adjust to height depending on the degree of the engagement of the screw (see FIG. 2). The screw fitting section 25 is provided with a slight play so as not to impede the rotation of the screw 21. The tip of the screw 21 abuts with the indented screw fitting section 25 (FIG. 2). Although the description has explained an example provided with the screw 21 only on a corner section of the frame-shaped IC mount 20, the positional shapes or the number thereof are merely exemplary and plural variations may be employed. For example, the screw may be provided between the corner sections of the frame-shaped IC mount 20.

The screw 21 is threadably engaged towards the rear face of the IC mount 20 from a screw hole 24 provided on the base 12 of the socket main body 10. In other words, the screw hole 24 is formed by providing a through hole in the base 12 corresponding to a corner section of the frame-shaped IC mount 20. The screw 21 is threadably engaged from the screw hole 24 to make contact towards the rear face of the IC mount 20.

In the first embodiment, a positioning unit specifying the height of the IC mount 20 is provided to set the IC mount 20 to a desirable height without requiring fine tuning. More precisely, a first screw lock 22 and a second screw lock 23 limiting the movement of the screw 21 are provided to function as positioning unit (refer to FIG. 1). These screw locks are freely inserted to extend in a horizontal direction from the side plate of the socket main body 10 toward the screw holes 24 provided in the base 12.

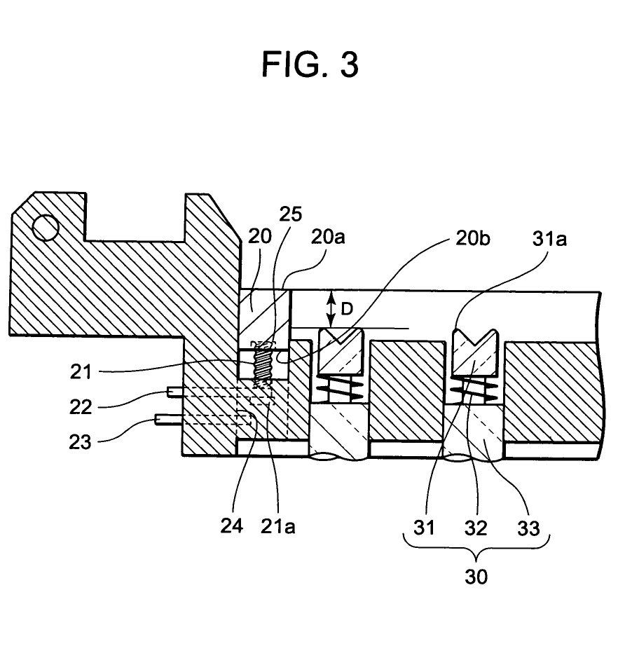

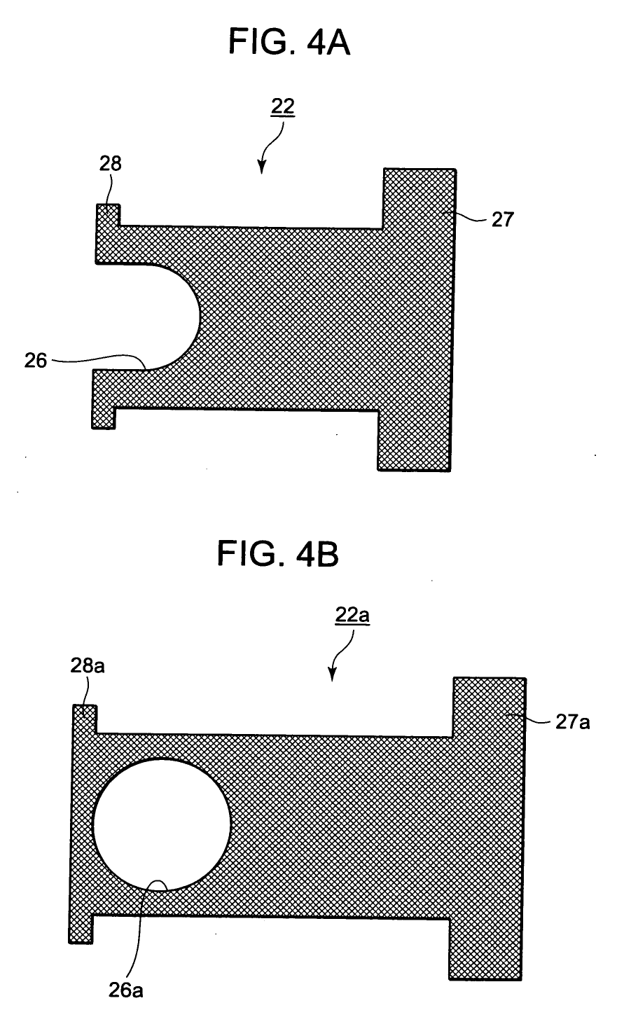

FIG. 3 shows a cutaway enlarged sectional view of a contact pin 30 and an IC mount 20. FIG. 4A and FIG. 4B show a schematic plan view of an example of a first screw lock.

As shown in FIG. 3, a screw fitting section 25 is provided on the rear face 20b of the IC mount 20 as described above. A head 21b of the screw 21 on the side opposite the tip of the screw 21 comes into abutment with the screw lock (the first screw lock 22 or the second screw lock 23) to limit upward movement of the screw 21. The screw lock functions to maintain the screw 21 to an optimal position. As a result, the position of the IC mount is determined.

The position of the first screw lock 22 and the second screw lock 23 is determined during manufacture of the IC socket 1 to a pre-set position at which the separation distance D between the upper surface of the contact terminal 31 and the upper surface 20a of the IC mount 20 is optimized to maintain a normal electrical connection between the electrode terminal of the IC package to be measured and the contact terminal of the contact pin 30. In this manner, anyone can adjust the IC mount 20 to a desired height without fine tuning.

A semicircular screw engaging section 26 engaging with the screw 21 is formed on the first screw lock 22 as shown in FIG. 4A. A female thread engaging with a male thread of the screw 21 is cut into the side face of the screw engaging section 26. The screw 21 can be adjusted to shift freely in a vertical direction with respect to the screw hole 24 by screwing the male thread of the screw 21 into the female thread of the screw engaging section 26. As shown in FIG. 4A, a position determining section 27 is provided on the first screw lock 22 so position the screw 5 21 and the screw engaging section 26 to a desired position. The screw engaging section 26 of the first screw lock 22 is positioned to engaged with the screw 21 as a result of the position determining section 27 pressing the first screw lock 22 until it engages with an engaging section (not shown) formed on the side of the socket main body 10.

A stopper 28 is provided on the first screw lock 22 to prevent the first screw lock 22 from deviating from the socket main body 10 towards the side facing the position determining section 27. When the screw lock is exchanged, firstly the screw 21 is loosened. Then stopper 28 draws out the screw lock fitted into the screw hole 24 until it engaged with the engaging section (not shown) formed in the inner side of the side late of the socket main body 10. In this manner, the screw lock which is fitted into the screw hole 24 can be removed from the screw hole 24.

A circular screw engaging section 26 engaging with the screw 21 is formed on the first screw lock 22a as shown in FIG. 4B. A female thread engaging with the male thread of the screw 21 is cut into a side face of the provided on the screw engaging section 26a. Thus it is possible to adjust the screw 21 freely and upwardly in a vertical direction from the side of the screw hole 24 using the male thread of the screw 21 and the female thread of the screw engaging section 26a. The position determining section 27a and the stopper 28a are formed in the same manner as the first screw lock 22 as shown in FIG. 4A.

In the first embodiment, a screw lock having a semicircular screw engaging section 26 as shown in FIG. 4A is used. In this manner, exchanging for another screw lock is possible without removing from the screw lock mounting the screw 21.

In the first embodiment, the example was described making reference to two screw locks (a first screw lock 22 and a second screw lock 23) disposed with respect to a vertical direction. However a suitable number of screw locks may be provided corresponding to the number of electrode terminals in the IC package to be measured. Furthermore detachable screw locks may be prepared, and plural grooves allowing attachment and detachment of screw locks may be provided on the side plate of the socket main body 10 in order to attach screw locks to a desired position. Various variations to the positioning unit may be made without deviating from the spirit of the present invention. In the present invention, it is not always necessary to use a position determining unit such as a screw lock and for example, the screws may be adjusted to a desired height individually.

It is possible to set the separation distance D (refer to FIG. 3) between the surface 31a of the contact terminal 31 provided on the contact pin 30 and the upper surface 20a of the IC mount 20 to a desired distance by setting the IC mount 20 to a desired height. As a result, it is possible to make the IC socket 1 multipurpose by setting the separation distance D in response to the shape of the electrode terminal of the IC package mounted into the IC socket 1.

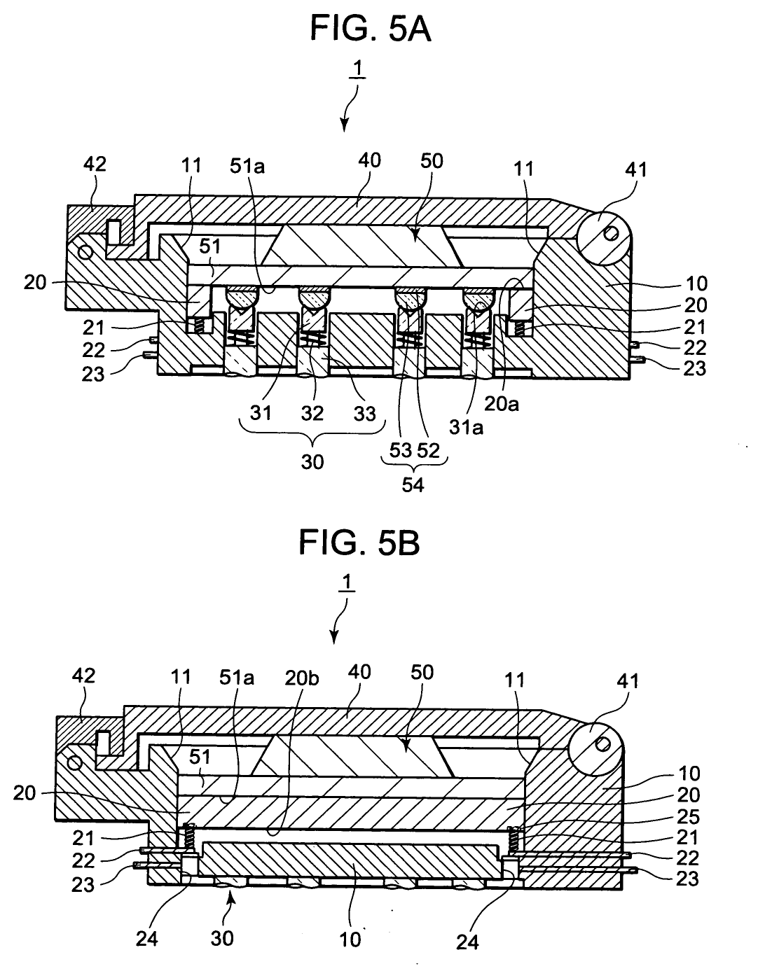

FIG. 5A and FIG. 5B shows a sectional view of the IC package 50 actually mounted.

FIG. 5A is a cross sectional view along the line V(a)-V(a) in FIG. 2. FIG. 5B is a cross sectional view along the line V(b)-V(b) in FIG. 2.

The IC package 50 is provided with an electrode terminal 54 formed as an array and a rectangular substrate 51 provided with the electrode terminal. The electrode terminal 54 is provided with a ball-shaped terminal (hereafter “ball terminal”) 53 and a land 52 provided on the surface of the substrate 51 and connected to the ball terminal 53. The electrode terminal 54 has the function of connecting the wiring from the IC to the outer section of the IC package. The IC package 50 according to the first embodiment is a grid array type package in which the electrode terminals are arranged in a lattice, and is a so-called BGA package in which the terminals are arranged in a ball shape. The ball terminal 53 is for example a solder ball.

The first screw lock 22 is formed at an optimal position when the ball terminal 53 of the IC package 50 abuts with the contact terminal 31 of the contact pin 30. This shape of the electrode terminal 54 is merely exemplary and the IC socket of the present invention can be adapted to electrode terminals of various shapes.

Before setting the IC package 50 in the IC packet 1, the height of the screw 21 is adjusted in response to the electrode terminal of the mounted IC package so that the separation distance D of the IC mount 20 and the contact terminal 31 is maintained in normal electrical connection. In the first embodiment, the position determining section 27 of the first screw lock 22 is pressed up to the engaging section (not shown) on the side plate of the socket main body 10.

Next the screw 21 is screwed in from the screw hole 24 provided on the base 12 of the socket main body 10 until the first screw lock 22. In this manner, the separation distance D of the upper face 20a of the IC mount 20 and the upper face 31a of the contact terminal 31 is set to a position ensuring a good electrical connection of the contact terminal 31 and the electrode terminal 54 of the IC package 50.

After setting the IC mount 20 to a desired position, the latch 42 is released, the lid 40 is rotated and the IC socket is opened. Next the IC package 50 is mounted on the determined IC mount 20.

In this manner, the contact terminal 31 of the contact pin 30 and the electrode terminal of the IC package 50 are brought into contact. Thereafter the lid 40 is closed and fixed to the socket main body 10 by the latch 42. The characteristics test is conducted by electrically connecting the circuit board of the IC test device with the contact pin 30 of the IC socket 1.

When performing the characteristics test on an IC package having a different shaped electrode terminal, the screw 21 is loosened once, a different screw lock is set and the height of the IC mount 20 is adjusted using the screw 21.

According to the IC socket 1 of the present invention, a good level of the flatness in the IC package 50 mounted using the IC mount 20 can be maintained. As shown in FIG. 5A and FIG. 5B, a proximal region of an outer peripheral section of the substrate face 51a forming the electrode terminal 54 of the substrate 51 of the IC package 50 is supported by abutting with the IC mount 20. Consequently stability is excellent.

According to the IC socket 1 in the first embodiment, it is possible to adjust the separation distance of the contact terminal 31 and the IC mount 20 using an IC mount shifting unit so that normal electrical connection is maintained in response to the shape of the electrode terminal disposed on the IC package. Thus multipurpose use of the IC socket 1 is possible with respect to plural different IC packages.

However during the manufacturing process of the IC package, manufacture of high reliability articles and increasing yield is important. When defective articles are detected during outgoing inspection of IC packages, sufficient analysis of the defects to elucidate the cause and formulate a solution is desirable in order to increase yield and provided highly reliable products. The outgoing inspection of BGA IC packages is formally conducted by examining the state of the ball terminals.

According to the IC socket 1 of the first embodiment, defect analysis can be performed on the land before mounting the ball terminal. In this case, the separation distance D of the upper surface 31a of the contact terminal 31 and the upper surface 20a of the IC mount 20 is adjusted taking into account the height of the land without a ball terminal 53 mounted thereon.

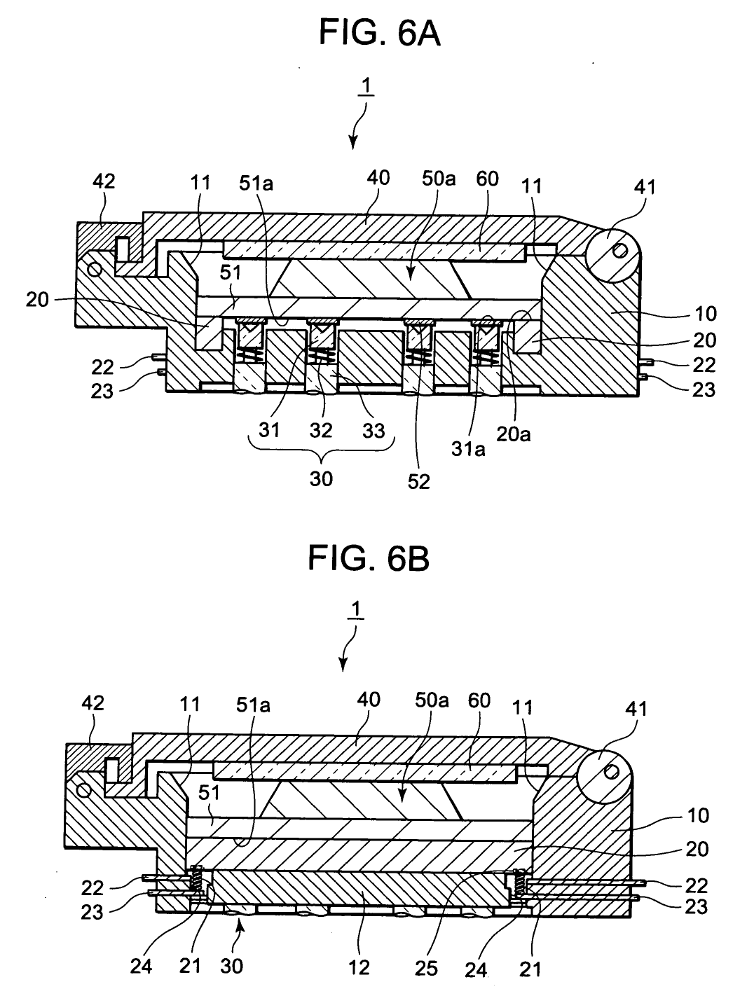

FIG. 6A and FIG. 6B show a sectional view when a component without a ball terminal 53 mounted thereon, in other words, a component in which the land 52 is exposed as an electrode terminal is mounted as the electrode terminal of the IC package 50a. FIG. 6A a cross sectional view of FIG. 5A and FIG. 6B corresponds to FIG. 5B.

In the first embodiment, the second screw lock 23 is formed at an optimal position when, of the electrode terminals 54, the exposed land 52 without a ball terminal 53 mounted thereon abuts with the contact terminal 31 of the contact pin 30.

During defect analysis, firstly the height of the screw 21 is adjusted to the position of the second screw lock 23 to coincide with the mounted IC package 50a. In other words, the screw 21 is loosened and the first screw lock 22 is drawn out and removed from the screw hole 24 on the side plate of the socket main body. The position determining section 27 of the second screw lock 23 is pressed in until making contact with the engaging section (not shown) provided on the side plate of the socket main body 10. In this manner, the second screw lock 23 is provided in the optimal position at which the female thread which is provided on the side face of the second screw lock 23 threadably engages with the male thread of the screw 21.

Then the head 21a of the screw 21 is pressed until the head of the screw makes contact with the second screw lock 23. In this manner, the separation distance between the upper face 20a of the IC mount 20 and the upper face 31a of the contact terminal 31 is suitably adjusted. Then an IC package 50a not provided with a ball terminal 53 for defect analysis is mounted on the IC mount 20. Thereafter electrical characteristics testing is performing using the same method as that described above.

When the IC package 50a is mounted in the IC socket 1, the IC mount 20 is depressed in a vertical direction by a distance corresponding to the difference of not mounting a ball terminal 53 in comparison an IC package 50 on which a ball terminal 53 is provided. As a result, a space is formed between the lid 40 and the upper face of the IC package 50a. A spacer 60 may be provided as required in the space between the lid 40 and the IC package 50a so that the IC package is placed in suitable abutment with the IC mount 20.

The method of mounting the spacer 60 detachably on the lid 40 is not particularly limited and may be performed using a known method. For example an engagement member maybe provided respectively in the spacer 60 and the lid 40 and attachment performed by engaging such members. Furthermore a sponge shaped spacer maybe fixed to the lid 40 and the IC package maybe placed in suitable abutment with the IC mount 20 irrespective of the height of the IC package. Furthermore the height of the lid (base) may be adjusted using a conventional technique. When the IC package is placed in suitable abutment with the IC mount 20, the structure of the base may take any arrangement.

The contact pressure between the electrode terminal and the contact terminal can be retained at a substantially fixed value with respect to an electrode terminal 54 comprising a land 52 and a ball terminal 53 after mounting the ball terminal, and an electrode terminal 54 comprising a land before mounting the ball terminal. In this manner, it is possible to perform very accurate electrical characteristics testing. Costs can be reduced when performing defect analysis by not forming a ball terminal 53 and performing the inspection using the condition of the land 52 and using a common-use IC socket.

In the first related example, a method may be conceived of sharing the IC socket at electrode terminals comprising ball terminals and lands and at electrode terminals comprising lands before mounting the ball terminals by lengthening the spring member and increasing the stroke of the contact terminal. However maintaining the contact pressure between the electrode terminal and the contact terminal to a fixed value is difficult using this method. Furthermore since the spring member is lengthened, there is the problem that high frequency characteristics will deteriorate due to an increase in the parasitic components of the socket pin.

According to the first embodiment, the level of sinking of the contact terminal 31 can be maintained to a fixed value by varying the separation distance D of the upper face 20a of the IC mount 20 and the upper face 31a of the contact terminal 31 in response to the shape of the electrode terminal. In this manner, the contact pressure of the electrode terminal and the contact terminal can be maintained to a fixed value and it is possible to equilibrate the contact conditions irrespective of the shape of the electrode terminal. The spring member provided on the contact pin 30 may be provided with a buffering function or and the length of the spring member may be slight. Thus the component limited by the spring member does not increase and it is possible to prevent deterioration of high frequency characteristics.

According to the first embodiment, the height of the screw lock could be adjusted by a “screw”. Consequently the exchange operation for the IC socket as described in Patent Document 4 for example is not required. Moreover the method of operation is simplified since the height of the screw lock is adjusted by a threaded arrangement. Since assembly is simple, setting is facilitated. Furthermore according to the first embodiment there is the advantage that there is no requirement to detach or attach a screw lock adjustment unit from the device and thus maintenance is simplified. Use of a screw allows for minute adjustment of the height.

According to the first embodiment, since the IC mount 20 is formed in a frame shape, flatness is excellent. Since the structure is simple, manufacturing is simplified.

According to the first embodiment, an example was described making reference to an IC mount 20 having a frame shape. However the invention is not limited in this regard and as long as it is possible to mount and abut the substrate face on the electrode terminal side of the IC package, various modifications are possible. For example, the mount may be composed by an elongated mount facing the direction X or the direction Y in FIG. 2. Furthermore although the electrode terminal was described using an example of a BGA terminal, the invention is not limited in this regard and for example, a LGA (Land Grid Array) type of package may also be used.

### Second Embodiment

Next an example of an IC socket which is different from the first embodiment will be described. In the following description, those components which are the same as those described with reference to the embodiment above are denoted by the same reference numbers and additional description will be omitted.

An IC packet according to the second embodiment has the same structure as the first embodiment with the exception of the following points. That is to say, the IC mount 20 according to the first embodiment was frame-shaped. However the mount according to the second embodiment is formed as a plate-shaped body provided with an array of through holes positioned corresponding to the contact pins 30.

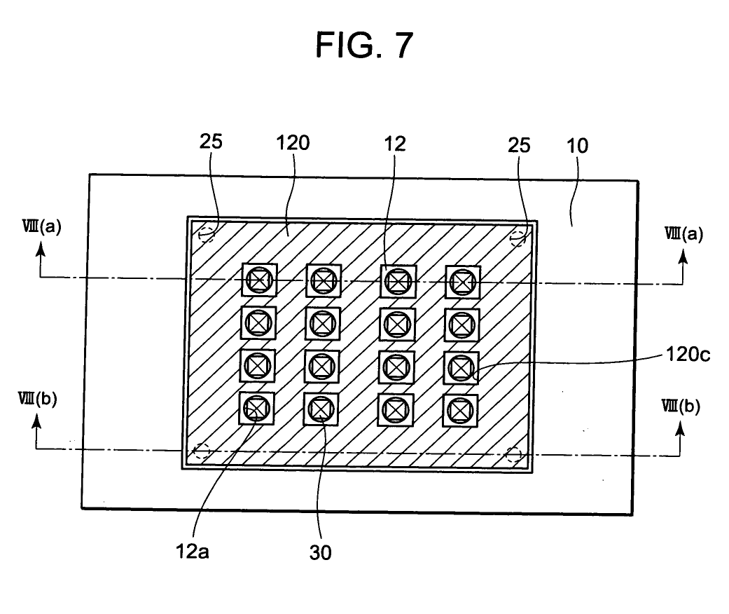

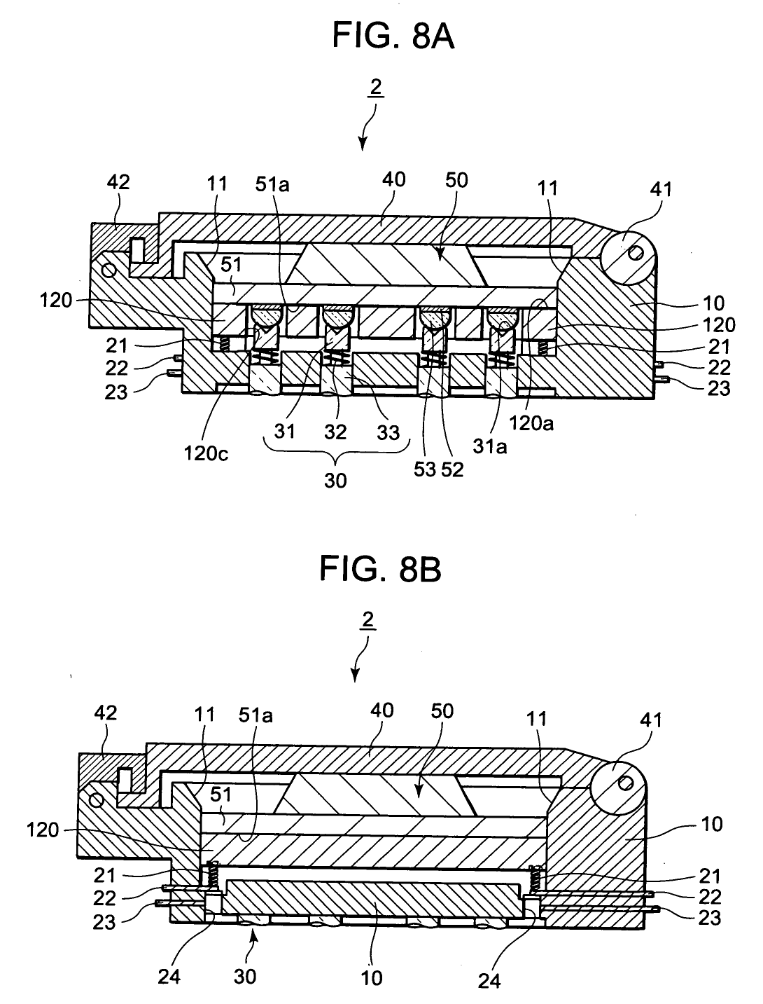

FIG. 7 shows a schematic plan view of the main components of an IC socket 2 according to a second embodiment. FIG. 8A is a cross sectional view along the line VIII(a)-VIII(a) in FIG. 7 and FIG. 8B is a cross sectional view along the line VIII(b)-VIII(b) in FIG. 7.

As shown in FIG. 7, the IC mount 120 is formed by a rectangular plate-shaped body. Plural through holes 120c are arranged in a lattice shape to place the contact terminals 31 of the contact pin 30 and the electrode terminals of the IC package in contact. The screw fitting section 25 and the screw 21 are provided in the four corner sections in the rear face of the IC mount 120 in the same manner as the first embodiment.

According to the second embodiment, the same effect as the first embodiment can be obtained. Furthermore rigidity can be increased by increasing the width of the contact surface between the IC mount and the substrate face of the IC package by forming the IC mount into a plate shape body. Consequently, stability of the mounting of the IC package is increased. This is particularly effective when the IC package tends to deform. As shown in FIG. 8A, an IC package is mounted so that the electrode terminal engages with the through hole 120c provided on the IC mount 120. Thus the through hole 120c itself has a function as a positioning guide.

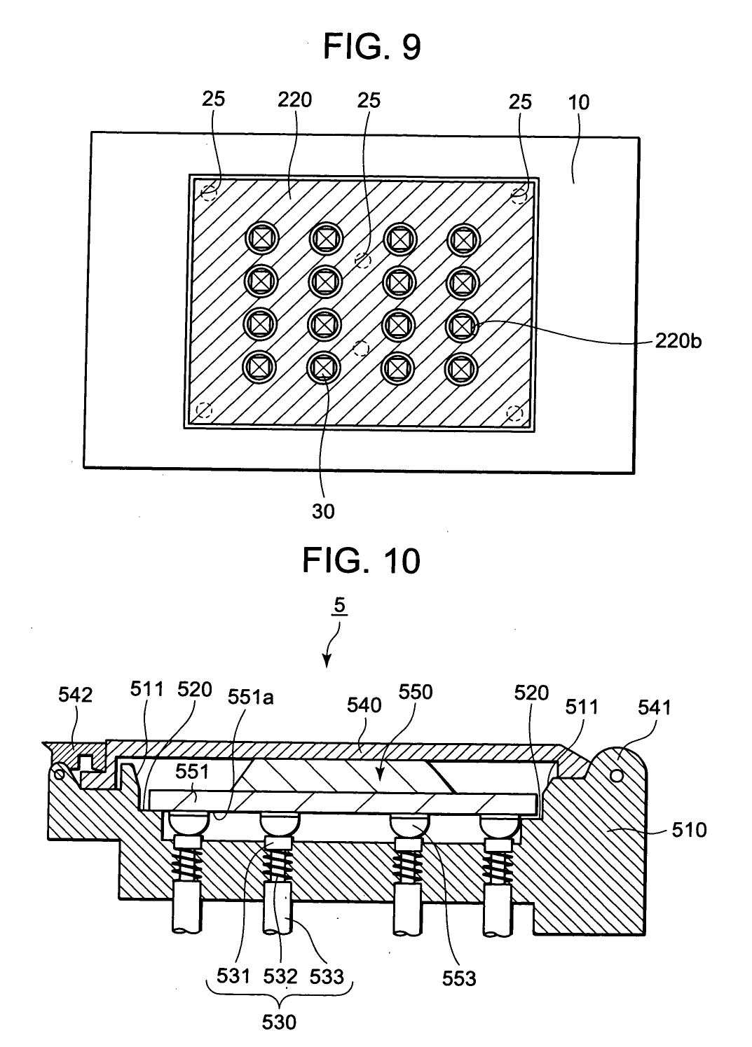

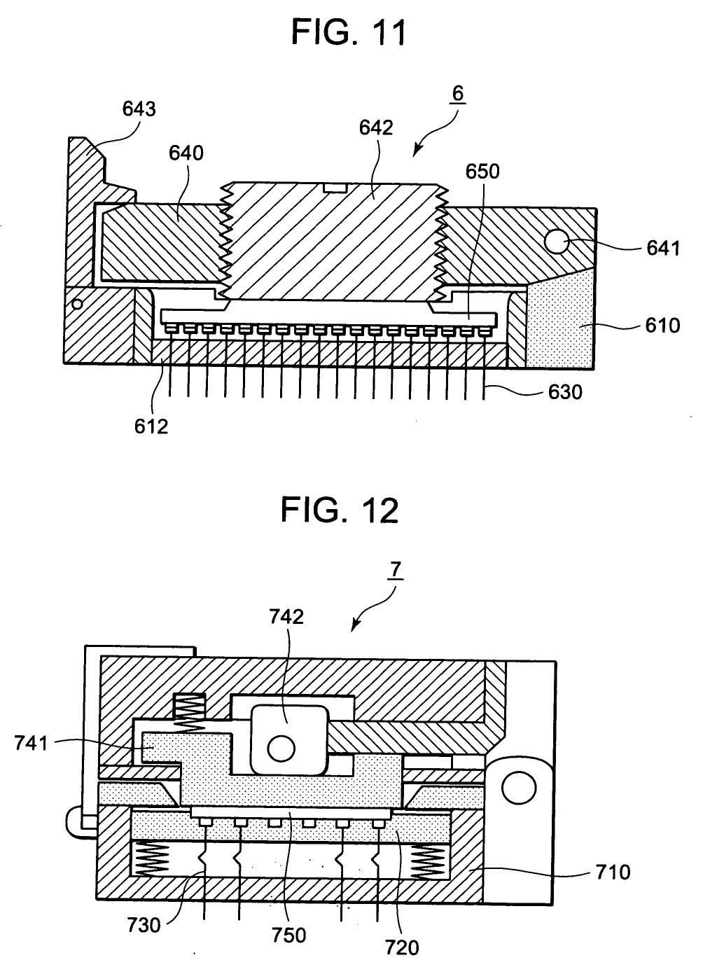

In the second embodiment, an example has been given of a lattice shaped through hole seen in plan orientation as an example of a through hole 120c of an IC mount 120. As shown in FIG. 9, a through hole 120c of an IC mount 120 may be a circular through whole when seen in plan. This circular shape is the minimum size allowing contact of the electrode terminal of the IC package and the contact pin 30. The screw 21 is not limited to the example of providing a screw at four corner positions on the IC mount. For example, as shown in FIG. 9, a screw fitting section 25 may be added to the central region of the IC mount to allow abutment of the screw with this section as well.

According to the IC mount 220 shown in FIG. 9, the contact region with the substrate of the IC package may be further increased by using an IC mount 120 according to the second embodiment. Thus a more rigid IC socket is provided. Moreover since a screw makes contact with the central region of the IC mount 220, rigidity can be further increased. When the through hole 220c has a circular shape when seen in plan and a size in which the contact of the contact pin 30 and the electrode terminal of the IC package is a minimum, the through hole 220c has a function as an accurate positioning guide.

What is claimed is:

1. A socket for a semiconductor device comprising:
a contact terminal that places an electrode terminal of the semiconductor device in abutment and electrical connection;
an IC mount that mounts a substrate face where an electrode terminal of the semiconductor device has been formed; and
an adjustable IC mount shifting unit that enables adjustment of a separation distance between an upper surface of the contact terminal and an upper surface of the IC mount in order to maintain normal electrical connection between the contact terminal and an electrode terminal of the semiconductor device irrespective of the shape of an electrode terminal of the semiconductor device.

2. The socket for a semiconductor device according to claim 1, wherein the IC mount is formed in a frame shape so that a proximal region of the outer peripheral section of the substrate face where an electrode terminal of the semiconductor device has been formed abuts the IC mount and is mounted on the IC mount.

3. The socket for a semiconductor device according to claim 1, wherein the IC mount is formed as a plate-shaped body having a plurality of through holes for placing the contact terminal in contact with an electrode terminal of the semiconductor device.

4. The socket for a semiconductor device according to Claim 1, wherein the IC mount shifting unit is provided with a position determining unit to determine the height of the IC mount.

5. The socket for a semiconductor device according to claim 1, wherein the IC mount shifting unit is a unit for adjusting the height of the screw and has a screw placed in contact with respect to a rear face opposite to a mounting face of the semiconductor device on the IC mount.

6. The socket for a semiconductor device according to claim 5, wherein the height of the IC mount is determined by a screw lock of the screw.

7. A socket for a semiconductor device for testing electrical characteristics of a ball grid array semiconductor device, the socket comprising:
a contact terminal that places an electrode terminal of the semiconductor device in abutment and electrical connection;
an IC mount that mounts a substrate face where a ball-shaped terminal of the semiconductor device has been formed; and
an adjustable IC mount shifting unit that enables adjustment of a separation distance between an upper surface of the contact terminal and an upper surface of the IC mount in order to maintain normal electrical connection with the contact terminal respectively at the ball-shaped terminals of the semiconductor device and terminals composed of lands prior to formation of the ball-shaped terminal.
